(19) United States
(12) Patent Application Publication
(10) Pub. No.: US 2023/0347588 A1
(43) Pub. Date: Nov. 2, 2023

(54) METHOD AND DEVICE FOR 3D PRINTING

(71) Applicants: ETH-ZÜRICH, Zürich (CH); BERNER FACHHOCHSCHULE, Bern (CH)

(72) Inventors: Erich WINDHAB, He-mishofen (CH); Christoph DENKEL, Zürich (CH); Karl-Heinz SELBMANN, Riken (CH)

(21) Appl. No.: 17/796,460

(22) PCT Filed: Jan. 7, 2021
(86) PCT No.: PCT/EP2021/000003

§ 371 Date: Jul. 29, 2022

(30) Foreign Application Priority Data
Jan. 29, 2020 (DE) 10 2020 000 571.3

(51) Int. Cl. B29C 64/176; B33Y 10/00; B33Y 30/00; B29C 64/112; B29C 64/209; B29C 64/118; A23P 20/20; A23G 1/00; A23G 1/20

(52) U.S. Cl. CPC B29C 64/176; B33Y 10/00; B33Y 30/00; B29C 64/112; B29C 64/209; B29C 64/118; A23P 20/20; A23G 1/0063; A23G 1/205; B29L 2031/718

(57) ABSTRACT

The invention relates to a method for 3D printing of food, pharmaceutical products, cosmetics, and plastic or ceramic composite products, and to an apparatus for executing a method for 3D printing of these articles and products manufactured according to the method, and a control or regulating system for the apparatus for executing the method, and the use of the product bodies manufactured according to the method.

### CATEGORY

The invention relates to a method for 3D printing food, pharmaceutical products, cosmetics, and plastic or ceramic composite products.

The invention also relates to an apparatus for executing such a method.

The invention also relates to products produced with the method according to the invention, and a control or regulating system for the apparatus according to the invention.

Lastly, the invention relates to use of the products printed according to the invention.

### PRIOR ART

To ensure sufficient precision, conventional 3D printing methods use small printing nozzle diameters adapted to the design, so-called extrusion or jet nozzles, in order to construct products with a defined three-dimensional shape and desired surface quality from the product mass extruded in the form of a filament or droplet. The printing compound that is used for this must exhibit certain rheological characteristics in order to ensure sufficient bonding of successive filaments/droplets/layers as well as maintain its shape during the printing process, withstanding the prevailing flow pressures and hydrostatic pressure of the weight of the layers that are built up under the existing thermal boundary conditions. Under these boundary conditions, larger products with characteristic dimensions that are many times greater than the diameter of a single printed filament or single printed layer take many minutes to print. Although these 3D printing methods are suitable for producing single complex elements with “fast prototyping,” they are not suited for industrial production concepts in which products are manufactured on a large scale under industrial conditions.

U.S. Pat. No. 6,280,784 B1 describes various apparatuses and methods for producing food with flowing components, which are either discharged in the form of a filament to a substrate in the form of a table that can move three-dimensionally, or can be fed to a dosing apparatus that functions with gearwheels in the form of a mixture or conglomerate. The flow is then distributed to various channels, which lead to various nozzles, which are then connected to various feed devices with which other additives such as food coloring can be added to the filaments extruded from the various nozzles. The filaments are applied in layers through the nozzles and arranged in strips on top of one another to form a compound. The feed device can be controlled by a computer, and the material that is to be printed is delivered by pumps, extruders, or via valve controls. If individual nozzles are used, they are rigidly connected to one another and cannot be controlled separately such that they function independently of one another. A multi-scale functioning with a high level of precision is not possible with in this case.

A printer is described in WO 2014/110590 A1. Dimensional accuracy is of no concern in this printing process. The compounds that are extruded are arranged in layers on one another. It is not possible to print larger items with this apparatus.

WO 2017/215641 A1 discloses a printer with multiple nozzles joined firmly to one another, which cannot be controlled individually. It is not possible to print larger items with this apparatus.

WO 2019/199505 A1 describes a printing method for producing vitamin and/or pharmaceutical supplements. It is not possible to make a multi-scale 3D print with this method.

### OBJECT OF THE INVENTION

The fundamental object of the invention is to propose a 3D printing method for three-dimensional products that enables the printing of product bodies or product body parts composed of numerous different functionalizing compounds as well as product structures of different size scales, with relatively high precision under industrial conditions at relatively high speeds, in accordance with the invention.

It is also a fundamental object of the invention to create an apparatus for executing the method according to the invention, which enables production of 3D product bodies or 3D product body parts under industrial conditions with relatively narrow tolerances and at relatively high rates, according to the invention, in which the product bodies or product body parts are composed of numerous different functionalizing compounds and are of different size scales.

The invention also has the fundamental object of creating product bodies or product body parts that can be produced with the method according to the invention under industrial conditions within relatively narrow tolerances in comparison with conventional methods.

It is also a fundamental object of the invention to provide suitable uses for the products produced with the method according to the invention.

Lastly, the invention has the fundamental object of creating a means for controlling or regulating the apparatus according to the invention.

Achieving the Object Relating to the Method

This object is achieved by a method for 3D printing of food, pharmaceutical products, cosmetics, and composite products made of plastic, ceramic, metal, or natural materials, in which non-symmetrical products and/or non-symmetrical compounds are produced in various product size scales such as “macro,” measured in centimeters, “meso,” measured in millimeters, or “micro,” measured in micrometers, from flowing compounds, in which the respective product bodies or product body parts that are formed are each printed with an average product dimension of 5 cm in terms of their width, height and length, with a dimensional precision of 1,000 micrometers, or <600 micrometers, or <100 micrometers, and the printed product bodies or printed product body parts are each produced with an average product dimension of 5 cm in terms of their width, height, and length, with a mass of >10 g and a density of 0.1-1.5 g/cm3 in intervals of <60 seconds or <10 seconds.

Some of the Advantages

The method according to the invention enables simultaneous printing of relatively large product parts through nozzles with larger diameters, and joins synchronized printing processes thereto for product parts of medium or smaller sizes made with corresponding nozzles of medium/smaller diameters. These printing processes at different characteristic size scales are intermeshed with one another such that corresponding product parts of different dimensions are joined to one another in that the multi-scaled synchronized printing process combines a “construction” of corresponding product parts in synchronization with the printing process. The interaction of the corresponding instrumental/processing components for at least two, preferably more than two, printed product body sizes/product part sizes, is obtained according to the invention by means of a combined printer head-apparatus concept, based on a coordinated control or regulating system in conjunction with intercommunicating robots.

It is also of particular advantage in the method proposed according to the invention that the individual product sub-flows for printing product bodies or product body parts of different sizes (macro, meso, micro, or further subdivided) can be adjusted individually with regard to their flow properties, and separately determined functionalities with regard to resulting product properties can also be advantageously precisely obtained and placed in a defined manner in the product.

Higher flow limits are required with larger product parts, i.e. printed product bodies or product body parts, with regard to the rheological properties, in order to suppress the “melting resistance” after deposition of the printing compound. The flow limit can be substantially lower with smaller printed products or printed product parts, and just the surface tension or wetting effect can be used to ensure sufficient stability of the product body or product body part.

With regard to a selective functional product sub-flow optimization, e.g. with food systems, additives with certain aroma, flavor, color and texture components, or properties contributing to surface structure, can be used in a manner specific to the sub-flows. A product body or product body part can be generated from a sub-flow with this function, which ensures an improved effectiveness of the function that is to be obtained (e.g. aroma intensity, digestibility/bioavailability) in coordination with the physiological conditions in the oral cavity or gastrointestinal tract of the consumer. This can result in a substantial savings with regard to those components when these additives do not need to be added to the entirety of the product, as is normally the case, for functional reasons.

It has proven to be of particular advantage in the method according to the invention, that a specific placement/arrangement of the printed product bodies or printed product body parts of different characteristic dimensions may result in particular possibilities with which the functionality of the product can be affected. By way of example, very small droplets or line structures can be placed on certain parts of the product surface in order to obtain an enhanced interaction with mechanoreceptors and taste/smell receptors in the oral cavity or in the retronasal smell cavity (e.g. through quick enrichment of the exhaled air with volatile aroma components) of the consumer when consuming the product. This can result in a “boost” in flavor or smell.

The reduction of sugar, salt and fats is of particular interest for the consumer in this context, in order to satisfy the recommendations of WHO in this regard, in particular in numerous foods. Printed surface structures are regarded as suitable for enhancing both sweet and savory flavors, without having to add sugar and/or salt to the entireties of certain products. Printed surface structures can also be adapted to the formation of certain wetting properties of the tongue and gums, and thus associated possibilities for generating “fatty” lubricating properties.

Novel products/product bodies or product body parts can be obtained on the basis of the advantages of the method according to the invention described above, which have product qualities that have been improved significantly over those of earlier products with regard to functionality and the potential for economic savings with regard to functionalizing ingredients, and which can be produced in the future at greater speeds with greater dimensional stability in accordance with the invention. Furthermore, the above, novel product qualities and functionalities are of great interest from the perspective of the consumer/user with regard to their sensory preferences, as well as health-relevant nutritional aspects.

Based on this, the SYnchrone Multi-Scale 3D printing (SYMUS) technology can offer new production possibilities in the fields of food, cosmetics, building materials, pharmaceuticals, ceramics, plastics and chemical industries.

A particular advantage with this is that the approach proposed according to the invention enables narrower tolerances to be maintained at higher production output levels.

In order to automate the process, it is possible to store regulating algorithms and formulas in a central computer, which control and regulate two or more, in particular multi-axle robots with appropriate printers, such that these robot printers move in a controlled or regulated manner, and supply the compounds that are to be printed, e.g. chocolate compounds or compounds similar to chocolate, to the printers from appropriate storage containers in a controlled and regulated manner specific to the formula, in order to produce appropriate printed product body parts therefrom, e.g. for chocolate bars, etc.

The robot systems coupled to these printers can place products on appropriate transport devices, e.g. continuously or intermittently operated conveyors, which convey the printed products to either an appropriate packaging station and/or a storage area.

It is possible to control and/or regulate numerous robots and their printers with one or more computers, in order to produce identical or different printed product bodies, e.g. chocolate bars with different fillings, on parallel and/or successive conveyors, simultaneously, separately, or in random mixtures, controlled or regulated by a central computer, at a high production output while still maintaining the prescribed narrow tolerances.

The printers can have individual or separate dedicated heating and cooling devices in order to print the product bodies or product body parts.

This combination of printers that simultaneously print product parts of different size scales and construct the products, in which it is possible to work with numerous nozzles of different sizes for the different product parts, results advantageously in much higher production rates than can be obtained with conventional 3D printing methods. It is not only possible to work at different size scales, which significantly reduces production times, but it is also possible to adapt the sizes of the nozzles and their shapes to the products and product parts such that the potential for simultaneous processing at different size scales can be fully exploited.

It is also extremely advantageous that numerous printer units periodically or simultaneously construct the product, resulting in substantial time reductions in the production process. Unlike with some established technologies, the method proposed herein makes it advantageously possible to also produce non-symmetrical products at higher speeds because it is possible to obtain significantly varied shapes through the additive construction and the interactions of numerous extrusion and/or printing systems, and it is also possible to change quickly from one product to another. It is also particularly advantageous that a product can be constructed from numerous compounds at significantly higher production speeds than with existing methods, and texture, flavor and smell sensory properties of a product can be adjusted locally on the product without difficulty. In particular the non-symmetric arrangement of compounds, which may also have different compositions, results in a great deal of freedom with regard to adjusting sensory properties in the case of foods, e.g. with regard to the perception of sweetness or scents.

Anisotropic arrangements in conjunction with specific effects of products that produce different textures cannot be obtained at all or with the same flexibility with conventional methods. In comparison with conventional methods there is also an additional advantageous flexibility in the method, in particular in that the appropriate printer units can be advantageously combined with one another or quickly exchanged. As a result, longer product parts can ideally be generated via extrusion printers with large nozzles, and the formation of smaller structures or the placement of functional, highly effective but smaller components ideally takes place with extrusion printers or jet printers with small nozzles.

The high dimensional accuracy, which is dependent on the precision of the movement and repositioning of the printing units or the associated robotic units as well as the shaping capacity and hardening properties of the compounds, is of particular advantage. A high level of dimensional accuracy is obtained through an optimal coordination of the materials, or their flow and hardening properties, to the production process. With products in which an extremely high level of dimensional accuracy is necessary, this can be ensured, for example, with a higher resolution using a printer that functions at a micro scale (<100 micrometer printing resolution) at the regions near the surface of the object that is to be printed, for example. This makes it possible to print product bodies and product body parts with greater dimensional accuracy according to industrial standards.

Product parts may be composed of materials with different types of structures, e.g. emulsions, suspensions (high density) or foams (low density). One particular advantage of the method according to the invention is that these different types of materials can be readily placed next to one another in a product and remain substantially unmixed, such that new sensory perceptions can be derived therefrom. All of these structural types of materials can be readily processed and placed with appropriately adjusted extrusion and/or jet printers, selectively and in a variety of forms (e.g. filaments or droplets). The production speeds that can be obtained for a product depend on which functionalities and associated arrangements of the individual printing compounds are intended in the products. Simple, preferably symmetrical products composed of three compounds (e.g. hollow body compounds, fillers, and surface structuring compounds) in which the latter is applied with a jet printer, can be produced in a few seconds. More complex, anisotropic structures, asymmetrical product shapes composed of three different compounds, in which levels of functional components are to be constructed, require more time (ca. 50-60 seconds), but they have a particularly higher sensory consumer benefit.

### Further Inventive Aspects

A method is described in claim 2 in which the product body is produced with a dimensional accuracy (FH) of >95%, in which this is obtained as a standard for a deviation in the product body dimensions or product body part dimensions and/or the cross section dimensions of the printed product body or product body part from a target value of <5%.

This results in the advantage that a precision in terms of fitting into a packaging and the undisrupted operation of the packaging apparatus in question can be guaranteed.

According to claim 3, extrusion and/or jet printing methods are used for the production, in which the compounds that are discharged are bonded to previously discharged, hardened and/or partially hardened compounds and/or compound parts through sintering, adhesion, or welding.

For a synchronized or partially synchronized and multi-scaled product construction, it is essential to be able to bond newly discharged compounds to partially hardened or hardened compounds. This bonding normally takes place by partially melting or sintering the (partially) hardened compound with a portion of the thermal energy from the newly discharged compound. Depending on the properties of the material, this can also be obtained with adhesion, and in some cases welding, e.g. with the use of a further energy source such as a laser. Depending on the properties of the compound, the extent of the bonding between two layers can be controlled through a precise control of the temperatures or the specific energy being applied, such that the functional properties of the specific compounds are substantially maintained, or the texture of food in the case of a defined structural change in a remelted layer can be used to obtain a targeted structural/textural quality.

Claim 4 describes a method with which the extent of the adhesion, sintering or welding is controlled or regulated by the compound-specific processing parameters, e.g. temperature and/or filament contact pressure, as well as the material-specific parameters for flow behavior, e.g. more fluid or more solid—more crystalline or more amorphic, or temperature-dependent solidifying, or ion type/ion concentration dependent more gel-binding—phase fractions in the compounds.

These options for controlling the bonding between compounds are dependent on the compounds and their compositions. The extrusion pressure is important with regard to enlarging the contact surface area as well as the solidification mechanism in general. Depending on the process, the high flexibility with regard to the printing compounds that are used is advantageous. Consequently, the various bonding mechanisms between two layers can be managed in a flexible manner and used adjacently to one another (in the same product).

Claim 5 describes a method in which for each of the product bodies/product body parts that are to be printed, a printer is used that has been adjusted to the respective product size scale, composed of a print head with an appropriate print head characteristic, dosing unit, temperature control unit and a robotic apparatus, which form a production unit, in which the printer can be coupled to or replaced by another printer on the robotic apparatus via a bayonet mount, wherein the components of the printer and the robotic apparatus can be controlled or regulated in a programmable manner, coordinated to one another temporally and spatially, and two or more of these production units, functioning partially to entirely simultaneously, print the product bodies or product body parts of different product size scales at controlled speeds, and place these parts during the printing such that a previously determined spatial arrangement and bonding are obtained.

### Achieving the Object Relating to the Apparatus

This object is achieved according to claim 6 in that for each of the product bodies/product body parts that are to be printed there is a printer adjusted to the respective product size scale, composed of a print head with an appropriate print head characteristic, dosing unit, temperature control unit, and a robotic device, which form a production unit, in which the printer can be coupled to or replaced on the robotic device via a bayonet mount, in which the components of the printer and the robotic device can be controlled or regulated in a programmable manner, coordinated to one another temporally and spatially, and two or more of these production units, functioning partially to entirely simultaneously, print the product bodies or product body parts of different product size scales at controlled speeds, and place these parts during the printing such that a predefined spatial arrangement and bonding are obtained.

The modular construction of a production unit composed of a printer (1), which comprises a print head (1.1), dosing unit (1.2) and temperature control unit (1.3), and a robotic device (2) is of particular advantage. This makes it possible to obtain a variety of combinations, and facilitates the high level of flexibility with regard to a quick adaptation to different products or production conditions. This is further facilitated by the bayonet mount, which allows for a quick replacement of the printer or robotic device.

### Further Inventive Aspects

Further inventive aspects are described in claims 7 to 10.

Claim 7 describes an apparatus in which each printer has a print head with one or more adjustable dosing units, each of which is connected to one or more replaceable compound storage/supply units.

The flexibility of the apparatus is advantageously further increased with the possibility of being able to also exchange a compound storage/supply unit connected to the dosing unit for each print head.

Claim 8 describes an apparatus in which the print heads generate individual droplets, sprays, or filaments with one or more dosing units, each of which is adapted to the rheological properties of the compounds that are to be printed.

The selectively adapted generation of individual droplets, sprays or filaments as “print elements” results in a desirably broad and flexible range for the fundamental shaping of the product parts that are to be printed. All three of these print forms (individual droplets, sprays, and filaments) can be obtained in principle in macro, meso, and microscales, even though individual droplets and sprays are mainly used on a micro, or possibly a mesoscale. The rheological properties of the compounds that are to be printed are coordinated to the targeted print form and the product parts that are to be created therewith. As such, filaments that are to be printed on a macroscale (in the centimeter range) require a sufficiently high viscosity and flow limit, while micro individual droplets (<100 micrometers) preferably have a low viscosity with an increased surface tension.

The advantageousness represented by claim 8 comprises the further expanded flexibility of the apparatus according to the invention through the selection of the print forms and the expanded range obtained through the adjustment of the rheological print compound properties for the product part structures to be printed in different size scales.

The apparatus is characterized according to claim 9 in that the respective dosing units are adapted to the rheological properties of the compounds that are to be printed and to the dosing kinetics of a dedicated actuator and nozzle geometry.

The advantageousness of the apparatus according to the invention addressed in claim 14 lies in the ability to coordinate the dosing kinetics and therefore the printing speed via (a) the adjustable rheological properties of the print compounds and (b) the coordinated geometry of the printing nozzle. This forms a further expansion in the freedom that can be used in adjusting the printing process, and therefore results in a further increase in flexibility.

An apparatus according to the invention is characterized according to claim 10 in that the print head is adapted to the rheological properties of the compounds in the range in which they are to be printed taking irreversible structure-changing tensions in the compounds into account via a temperature control thereof with a temperature adjustment precision of ±1° C., preferably ±0.5° C., more preferably ±0.1° C.

The sensitive adjustability of the rheological print compound properties via the compound temperature is advantageous. This can be more precisely adjusted in the print head if there is an adequate pre-adjustment in the compound storage/supply unit.

### Achieving the Object Relating to the Product

This object is first achieved according to claim 11 in that the product is some type of food, i.e. a chocolate product, sugar confectionery product, pasta, pastry/baked good, spread, cheese, snack composite, plant-based meat equivalent, milk product, fat product, cold cuts/pâté, dessert, or ice cream.

The subject matter of the invention enables the production of novel functionalized food products and product qualities with improved functionality with regard to sensory perceived aroma, taste, and texture properties (e.g. an aroma boost) as well as savings potentials with regard to functionalizing ingredients and their production at high speeds. The novel qualities and functionalities are of great interest from the perspective of the consumers/users with regard to their sensory preferences as well as health-relevant nutritional aspects.

Furthermore, the object can be achieved according to claim 12 in that the product is a cosmetic/care product, i.e. a lipstick or soap.

Novel product forms and the incorporation of various fragrances in various parts/zones of the cosmetic product result in ergonomic, aesthetic, and sensory advantages.

This object is also achieved according to claim 13 in that the product is a pharmaceutical product, i.e. a bandage, suppository, prosthesis, corset, artificial joint, support structure, or a surgical aid for setting bones.

The possibility of placing specific functionalities at a specific location (e.g. in bandages, releasable styptic substances in parts of an upper layer that comes in contact with a wound, adjacent to regions that sop up blood/wound secretions, printed with highly porous aerogel foams) advantageously allow for placements and uses that result in a variety of functions. With a 3D printing-based production of prostheses, large caliber base structures (e.g. joint bones) can be advantageously printed in short printing times with functional fine surface structures (e.g. an articular cartilage layer) optimally bonded thereto.

The product according to claim 14 is characterized in that it is a composite product comprised of two or more materials contained in the following group: plastics, ceramics, metals and natural materials, forming a supporting element, wooden component, prosthesis, corset, or artificial joint.

The particular advantage in this case is the possibility of placing numerous compounds that have specific functionalities in products in a defined manner, coordinated to the functions that are to be obtained therewith, and producing them simply in shorter production times (e.g. an artificial joint; see the description of claim 18 with regard to the use of “artificial” substances, e.g. fiber-reinforced polymers for macro-elements and a Teflon layer used for the socket lining).

Claim 15 describes product composed of two or more compounds of the same or different composition, in which the product bodies or product body parts produced from the compounds are of different sizes, and these product body parts are permanently secured or moveably connected to one another.

According to this claim, a product can either be composed of different compounds or the same compounds, which are then supplied from different printing units in different size scales to the product in the form of product parts or subsections. A product part or subsection is understood to be a coherent product unit that is generated by the actions of a printing unit. It is a substantial advantage of the method according to the invention that large volume, solid or hollow parts of a uniform composition are generated via a direct extrusion of these parts. At least two compounds of different compositions are necessary if gradients of a functional component are to be generated (in the case of food, e.g. containing sugar, salt, fat, and an aroma). The dimensions of the product parts with different functional component concentrations, and therefore their portion on the product, are determined on the basis of the intended effect. As a result, different gradients can be obtained with the same or even reduced concentrations of a functional component in the overall product to obtain customized perception characteristics.

Claim 16 describes a product in which the product functionality is determined with regard to feel, texture, appearance, or smell by the application-specific composition of the compounds used in the printing process with regard to the concentrations of the components that give the product its aroma, flavor, or texture, or by the respective arrangement of these compounds in the product body or product body parts, or by the shape of the product body or the product body parts, or by the details of the surface structure of the product body or product body parts in question.

In this case, the spatial arrangement of the various compounds that contain functional components is decisive in particular for the advantageous functionality of the product because the relevant receptors then come in contact with the functional component(s) at specific times. The intensity of the effect depends on the concentration of the functional component(s) as well as their location in the product and the “structural environment” of such a placement. When a functional component is placed on a product surface, for example, and the surface is textured such that the surface area is enlarged, the tongue and gums come in contact with the food in the initial phase of its consumption. Individual raised areas that are “printed” on the surface and melt, e.g. at body temperature, will automatically come in contact with receptors (e.g. tastebuds in the case of food). The specific product surface area enlarged by the surface structure results in a more intensive perception as a result of the improved propagation and distribution of the melting raised areas containing functional aroma and flavor components. The shape of the overall product also results in such an effect in that it can more readily adapt to the contours of the oral cavity/tongue/gums.

Claim 17 describes a product in which the formulas for one or more compounds are obtained from a nutritional perspective.

According to the invention, certain ingredients, in particular nutritional substances, can be included in one or more compounds, thus resulting in different product parts. As a result, smaller amounts of functional components of nutritional value that are unpleasant on a sensory level can be included such that they can be located within a product or product part so that they do not come in contact with the taste receptors in the mouth, or only come in contact therewith to a limited extent, but are then efficiently released in the gastrointestinal tract where they can have a physiological effect.

The product described in claim 18 is characterized in that the formulation of the compounds with regard to sugar and/or salt and/or fat content, and/or the content of other additives, and/or functionalizing components, is coordinated to the arrangement in the product body or product body parts in order to reduce the amounts of these components in the overall product without resulting in functional or sensory losses.

It has proven to be very advantageous that a non-uniform distribution of substances in particular in conjunction with the targeted placement and/or concentration thereof in the product can result in an increased or reduced perception of the functional components. There is normally a desire to reduce sugar content, while at the same time, there is a desire to make substances with nutritional value that are unpleasant to the senses less perceptible. In addition to the dependencies listed above, the microstructure of the compounds may play a substantial role in the perception, in particular if certain compounds do not fully melt in the mouth under normal physiological conditions and dwell times.

A product is described in claim 19 in which an application-specific composition or the respective arrangement of the compounds in the product body, or the dimensions of the product body or product body parts, or the shape of the product, or the detailed surface structure result in an intensity curve of the perception of sugar, salt, fat, or aroma that is a function of how long it takes to consume the product.

The method for producing products in which one or more functional components are distributed anisotropically, preferably between the outer layer and the core of a product has proven to be particularly advantageous. The disintegration of the product in the mouth, in particular through a controlled melting or dissolving (in saliva or in conjunction with a beverage) results in the functional components first being released in the directly accessible surface regions. The length of the respective melting or dissolving process is substantially controlled by the viscosity of the compound(s) containing the functional component(s) and their interaction with saliva and/or additional fluids (e.g. beverages). Lower viscosities and improved solubility result in a functional component being perceived substantially more intensively, but normally for a shorter period of time. In addition to the viscosity and solubility in saliva/beverage liquids, the structure of the compound also determines the intensity and length of time for which an aroma/flavor component will be perceived. By way of example, with an emulsion or foam-based structure there are significantly different release rates for the functional aroma/flavor components (normally significantly accelerated in the case of an emulsion).

Furthermore, water-in-oil (w/o) or oil-in-water (o/w) phase configurations can be used with functional components, which are soluble in the water or oil phase, and are released at an accelerated (contained in a continuous phase) or delayed (contained in a dispersed phase) rate in their release behavior in the oral cavity or the gastrointestinal tract, and thus become active. Furthermore, a functional component in the aqueous phase, which mixes significantly better with saliva than in an oil phase, is likewise released, and thus taking effect, at an accelerated rate.

A product is described in claim 20 in which the composition of the compounds forming the product body results in a reduction of the overall content of functionalizing components by means of a physiologically determined arrangement of the functionalized compounds, or the dimensions of the product body parts generated by these compounds, or the shape thereof, or the compound properties that affect the release of the components that determine the functions, without impairing the intended physiological effects thereof.

One substantial advantage of the invention is that substances such as sugar, salt, aromas, or other functionalizing components are placed in the product such that they are perceived to an optimum extent from a sensory perspective. It may therefore be advantageous in certain products to place a substantial portion of the sugar content within the overall product in the outer product layers, in part directly on the surface in the form of droplets, thus resulting in a modified sensory perception. With an intensified overall effect of a functional component in the perception thereof by the consumer, the concentration of the functional component can be lowered to the level at which it was originally perceived. This can either result in a savings in functional components (e.g. aromas) or an improvement in the overall nutritional quality of a product. In addition to the arrangement of the substances in the product and the arrangements and concrete shapes of product parts, the release properties of the compounds are also decisive with regard to the perception of the substances. As such, functional components can be placed in the spaces between crystals in crystalizing compounds such that they come in contact with the taste receptors in a more concentrated form.

In particular with chocolate or fatty compounds (e.g. spreads), the melting properties are an important criterion for the expression of the perception because a mixing of the chocolate/fat matrix with saliva results in particular in a diluting effect, such that the perception of the functional components is reduced when the melting process lasts longer.

### Achieving the Object Relating to the Control or Regulating System

This object is achieved according to claim 21 by a control or regulating system for an apparatus designed for flexible 3D printing of preferably non-symmetrical product bodies or non-symmetrically arranged compounds in these printed product bodies, from two product bodies or product body parts, partially to fully simultaneously printed at different product size scales—in the centimeter range, millimeter range, or micrometer range—by printers assigned to these product size scales—in the centimeter range, millimeter range, or micrometer range—with one or more multi-axle robots, with one or more computers, which control or regulate the printers according to product-specific data regarding the product bodies or product body parts that are to be printed, stored in a memory in the computer in question.

The coordination of the partially to fully synchronized, complex printing processes according to the invention for numerous compounds with numerous printers, and the simultaneously adjusted settings for the print compound flows must be regulated in a coordinated manner. This is advantageously accomplished using a computer, which not only controls the temporal sequencing of the individual overlapping procedures, but also implements an optimization thereof on the basis of cognitive algorithms (AI/machine learning).

### Further Inventive Aspects

Further inventive aspects of a control or regulating system are described in claims 22 to 25.

A control or regulating system according to the invention is described in claim 22 for flexible 3D printing of preferably non-symmetrical product bodies and/or non-symmetrically arranged compounds in these product bodies, comprising at least two preferably different flowing compounds printed partially to fully simultaneously in different product size scales, using these compounds and dedicated printers adapted to the various product size scales in which the at least two printing apparatuses in the production facility or production facilities, which have one or more multi-axle robots, have at least one dedicated central computer, which controls or regulates the printers and the robotic devices coupled thereto in terms of their movement sequences and printing speeds according to data stored in a memory in the computer in question, taking the rheology of the compounds that are to be printed into account, in which the adjustment of the printing compound temperatures via the respective temperature control unit is used as an additional correcting variable for the fine tuning of the rheological compound properties.

The coordination of the partially to fully synchronized complex printing processes for numerous compounds using numerous printers, the simultaneous adjustment of the printing compound flow, and the fine tuning of the printing compound flow properties via a fine tuning of the print head temperature require a substantially coordinated regulation. This is advantageously carried out by a computer, which, in addition to the temporal sequence regulation of the individual overlapping processes, also implements optimizations on the basis of cognitive algorithms (AI/machine learning). The possibility of a fine tuning of the compound temperature and therefore the rheological properties of the compound immediately before passing through the print nozzle in a flow temperature control unit integrated immediately upstream of or in the print head forms a significant advantage for the quick regulation of the printing processes.

In claim 23, a control and regulating apparatus is characterized in that the computers and the dedicated printers are incorporated in an independent daisy chain in a superordinate control or regulating algorithm.

By this means, the advantageousness of a hierarchical control and regulation system for the smooth interaction of numerous printer apparatuses in a production facility is realized in the manner of a compatible partial product printing for customized products.

A control or regulating system is described in claim 24 in which the central control or regulating unit controls or regulates conveyors that run continuously or intermittently to remove printed product bodies.

It is also advantageous to include the devices in the proximity of the production facility that interact therewith, such as the conveyors for the products/product parts that are printed, either for supporting the printing process or the removal thereof, which are then also taken into account in the control or regulation of the production facility.

### Achieving the Object Relating to the Use

The object is achieved according to claim 25 with a chocolate product, sugar confectionery product, pasta, pastry/baked good, spread, cheese, snack composite, plant-based meat equivalent, milk product, fat product, cold cuts/pâté, dessert, or ice cream, etc.

The substantial advantages are in the customized functionalization capabilities of such products with regard to (a) the sensory aroma, flavor, and textural properties, and (b) the functionalizing substance components that support the nutritional aspects and the health aspects and also result in savings potentials because of the possible physiologically preferential placement according to the invention, and the local concentration of these substance components coordinated to sensitivity thresholds.

The invention is illustrated, in part schematically, and in part as an exemplary embodiment, in the drawings. Therein:

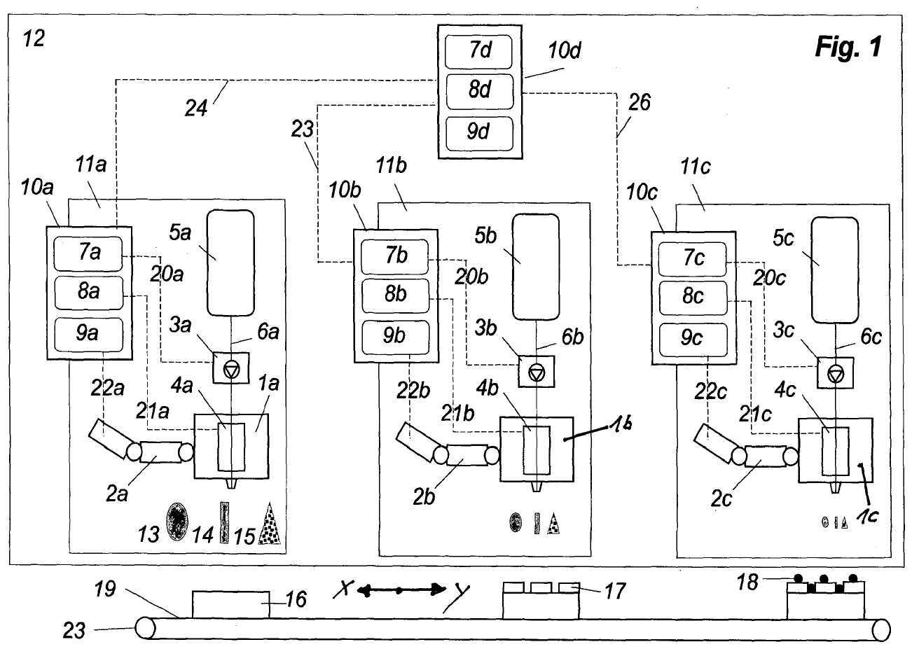

FIG. 1 shows a production facility in the form of a layout diagram;

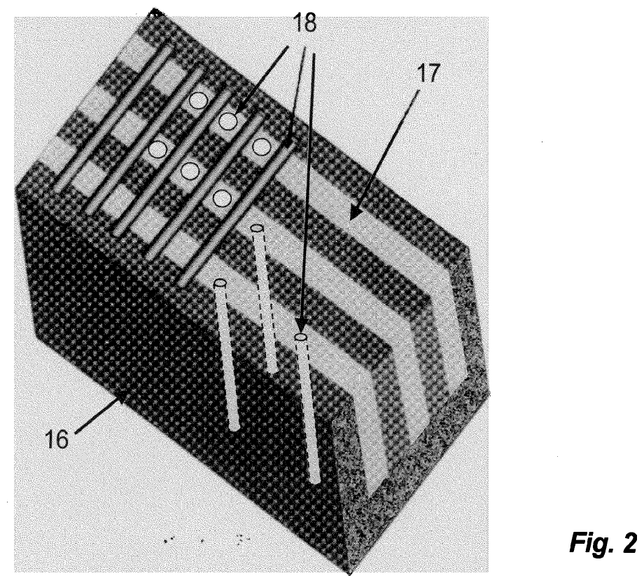

FIG. 2 shows a model of a synchronized multi-scaled 3D printed chocolate confectionery snack product; and

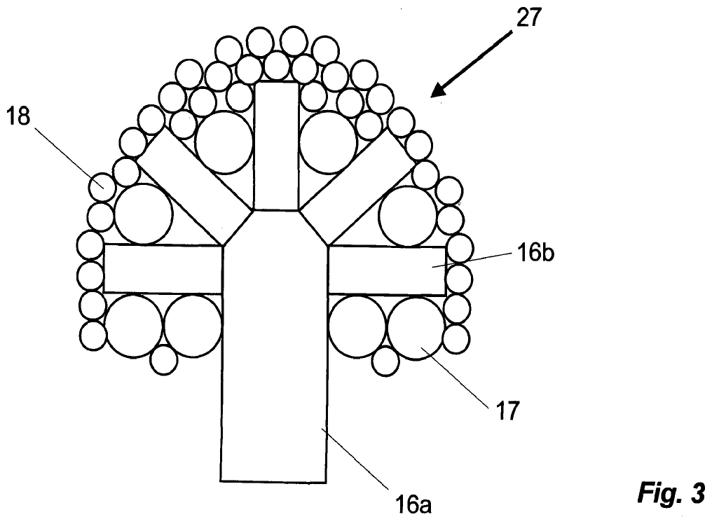

FIG. 3 shows, schematically, a (partially) synchronized multi-scaled 3D printed product body with macro, meso, and microscale product parts.

In FIG. 1, the components in which an “a” is added to the reference numeral belong to a printer 11a, which prints product parts on a macroscopic size scale. Accordingly, those with a “b” are components belonging to a printer 11b that prints product parts on a mesoscopic size scale, while those with a “c” are components belonging to a printer 11c that prints product parts on a microscopic size scale.

Print heads have the reference symbols 1a, 1b, and 1c, each of which are dedicated to multi-axle robot 2a, 2b, and 2c, respectively, the motors and power lines for which are not shown in detail for purposes of simplification. Each print head 1a, 1b, and 1c has a dedicated dosing unit 3a, 3b, and 3c, as well as a temperature control unit 4a, 4b, and 4c. The supply lines 6a, 6b, 6c are each connected to a material tank 5a, 5b, and 5c for conducting materials, via which the individual material flows can be fed to the respective print heads 1a, 1b, and 1c in a controlled or regulated manner, specific to a formula.

The reference symbols 10a, 10b, and 10c each indicate computers dedicated to the respective printers 11a, 11b, and 11c. The computers 10a, 10b, and 10c each have dedicated memories, not shown in detail, in which data for the respective formulas of the compounds that are to be printed and the product bodies that are to be printed, as well as the tolerance data and algorithms (including AI/machine learning based) for the temporal sequencing, are stored. The computers 10a, 10b, and 10c each have a control or regulating unit 7a, 7b, 7c for dosing the print materials supplied to the print head 1a, 1b, and 1c, respectively, and its dosing units 3a, 3b, and 3c.

Each control or regulating unit 8a, 8b, and 8c controls or regulates its respective temperature control unit 4a, 4b, and 4c.

Furthermore, 9a, 9b, and 9c indicate control or regulating units for controlling or regulating the movement of the multi-axle robots 2a, 2b, and 2c and their print heads 1a, 1b and 1c, and potentially other parts thereof.

The respective control and regulating units 7a, 7b, and 7c are each connected for signal transfer to their dedicated dosing units 3a, 3b, and 3c via a respective line 20a, 20b or 20c, while the control and regulating units 8a, 8b, and 8c for temperature control are each connected to the temperature control units 4a, 4b, and 4c via a respective line 21a, 21b, and 21c.

The control and regulating units 9a, 9b, and 9c are each connected to their respective robots 2a, 2b, and 2c via a line 22a, 22b, 22c for data transfer, to control the movements of the robots 2a, 2b, and 2c, respectively.

In the embodiment shown here, the relevant print head 1a, 1b or 1c can spray a spray jet 15 onto a substrate or a suitable base 19, or discharge a filament 14 onto the substrate or base 19, or print the print material in the form of droplets onto the substrate or base 19, depending on the design. Instead of a substrate 19, a conveyor 23 can be placed here, which transports the product bodies or product body parts printed by the printer 11a, 11b, or 11c with the print head 1a, 1b, or 1c, respectively, into the printing zone of another printer, e.g. 11b, 11c, which has another robot, e.g. 2b or 2c, which then prints the product body part printed by the printer 11a with other product body parts, and bonds them thereto, to form a completed product body. In the embodiment preferred according to the invention, the working areas of the printers 11a, 11b and 11c overlap spatially in order to obtain the partially to fully synchronized printing processes in the various size scales. The conveyor 23 supplements the movement sequences of the robots 2a, 2b and 2c in this case in a program-controlled manner, to minimize or optimize the travel paths.

FIG. 1 also shows a central control or regulating unit 10d for a production facility 12 composed of numerous printers 11a, 11b, 11c, in which formula-specific data and algorithms (including AI/machine learning based algorithms) are stored in a central memory for regulating the temporal sequence for the product body parts or product bodies that are to be printed in conjunction with the various printers 11a, 11b, 11c, in which the printers 11a, 11b, 11c are composed in turn of the respective print heads 1a, 1b, and 1c, the dosing units 3a, 3b, and 3c, the temperature control units 4a, 4b and 4c, and the respective dedicated robots 2a, 2b, and 2c.

The central control and regulating unit 10d is connected for data transfer to the three computers 10a, 10b, and 10c for the printers 11a, 11b, and 11c via lines 24, 25, 26, as shown by way of example in FIG. 1. This connection can also be wireless.

The computers 10a, 10b and 10c each have a dedicated multi-axle robot 2a, 2b, and 2c.

The printer 11a has a dedicated robot 2a with a print head 1a, a dosing unit 3a, and a temperature control unit 4a, with which relatively large printed product bodies 16 are generated, while the printer 11b has a dedicated robot 2b with a print head 1b, dosing unit 3b and temperature control unit 4b. The printer 11b prints product bodies 17 of medium size. The printer 11c with its robot 2c, print head 1c, dosing unit 3c and temperature control unit 4c prints small product bodies 18, which are placed on a product body 17, for example, which was printed in turn on a larger product body 16, printed by the print head 1a.

The conveyor 23 is driven in the direction X or Y, e.g. by an electric motor that can be regulated or controlled. The conveyor can be driven continuously or intermittently, controlled by the central control or regulating unit 10d in coordination with the robots 2a, 2b, or 2c, which have multiple axles, e.g. six axles.

Numerous production facilities can be arranged in parallel or successively and controlled or regulated by the central control or regulating unit 10d, such that different product bodies or product body parts can be printed simultaneously or successively, in parallel and/or in a series.

A production facility can generate a macroscopic 3D macro housing profile for a chocolate bar with different 3D cavities, insert a mesoscale filler body in parts of these cavities, and print microscale aroma capsule droplets in other cavities or on parts of the product surface (see FIG. 2 by way of example) in the field of chocolate confectionery technology with the associated printers 11a, 11b, and 11c (as shown by way of example in FIG. 1), for the partial to fully simultaneous printing of product parts on a macro (cm), meso (mm) and micro size scale 100 micrometers).

A relatively complicated product body structure, with the reference symbol 27, is shown schematically in FIG. 2, which is somewhat reminiscent of broccoli or cauliflower and is composed of two macro-product body parts 16a, 16b, eight meso-product body parts 17, and numerous micro-product body parts 18, the materials of which are integrally bonded to one another to form the overall product body 27 in the manner shown therein.

The various macro, meso, and microscale printed body parts are provided with the reference symbols 16a (macro), 17 (meso), and 18 (micro) in FIG. 3.

Aside from functionalized food and cosmetic products, body parts for automobiles, e.g. rocker panels, bumpers, struts with reinforcement fins and shock absorbing subsections can be printed in the manner according to the invention, in particular from composite construction materials. These product bodies are joined to the body with adhesive such that it is possible to produce weight-saving, multi-functional lightweight structures which satisfy the current endeavors to reduce fuel consumption and protect the environment.

### LIST OF REFERENCE SYMBOLS

1 print head
2 robot
2a dosing unit
3 dosing unit
4 dosing unit
5 temperature control unit
6 computer
7 control or regulating unit for the a dosing unit
8 control or regulating unit for the a dosing unit
9 control or regulating unit for the a dosing unit
10 line
11 line
12 line
13 line
14 line
15 line
16 material tank
17 material tank
18 material tank
19 spray jet
19a substrate
20 filament
21 droplet
22 control or regulating unit
23 line
24 line
25 line
26 control or regulating unit
27 control or regulating unit
28 control or regulating unit
29 robot
30 robot
31 robot
32 print heat
33 product body
33a print head
34 product body
35 print head
36 conveyor
37 product body
38 product body part
X-Y direction of conveyance

### LIST OF CITED DOCUMENTS

U.S. Pat. No. 6,280,784 B1
WO 2014/110590 A1
WO 2017/215641 A1
WO 2019/199505 A1
WO 2020/152689 A1

1-25. (canceled)

26. A method for simultaneous 3D printing of large product parts by means of synchronized printing processes, such as food, pharmaceutical products, cosmetics, and composite products made of, plastic, ceramic, or metal and natural substances, as non-symmetrical product bodies (16b, 17, 18) and/or non-symmetrically arranged compounds at different product size scales such as macro (in the centimeter range), meso (in the millimeter range), or micro (in the micrometer range), from flowable compounds, wherein the respective product bodies (16b, 17, 18) or product body parts that have been generated, are printed in each case with an average product size of 5 cm in terms of the width, height and length, with a precision of 1,000 micrometers, or <600 micrometers, or <100 micrometers, and the printed product body or printed product body parts are produced in a time interval of <60 seconds or <10 seconds, in each case with an average size of 5 cm in terms of the width, height, and length, a mass of >10 g and a density of 0.1 to 1.5 g/cm3.

27. The method according to claim 26, characterized in that the generated product bodies (16b, 17, 18) are produced with a shape retention (FH) of >95%, wherein this is obtained as a standard for a deviation in the product body dimensions or product body part dimensions and/or the cross section dimensions of the printed product body (16b, 17, 18) or product body part from a target value of <5%.

28. The method according to claim 26, characterized in that extrusion and/or jet printing methods are used for the production, wherein the compounds that are discharged are bonded to previously discharged, hardened and/or partially hardened compounds/compound portions by sintering, gluing, or welding.

29. The method according to claim 28, characterized in that the extent of the adhesion, sintering or welding is controlled or regulated by the compound-specific processing parameters, e.g. temperature and/or filament contact pressure, as well as the material-specific parameters for flow behavior, e.g. more fluid or more solid—more crystalline or more amorphic, or temperature-dependent solidifying, or ion type/ion concentration dependent more gel-binding—phase fractions in the compounds.

30. The method according to claim 26, characterized in that for each of the product bodies/product body parts (16b, 17, 18) that are to be printed, a printer (11a, 11b, 11c) is used that has been adjusted to the respective product size scale, composed of a print head (1a, 1b, 1c) with an appropriate print head characteristic, dosing unit (3a, 3b, 3c), temperature control unit (4a, 4b, 4c) and a robotic apparatus (2a, 2b, 2c), which form a production unit, wherein the printer (11a, 11b, 11c) can be coupled to or replaced by another printer (11a, 11b, 11c) on the robotic apparatus (2a, 2b, 2c) via a bayonet mount, wherein the components of the printer (11a, 11b, 11c) and the robotic apparatus (2a, 2b, 2c) can be controlled or regulated in a programmable manner, coordinated to one another temporally and spatially, and two or more of these production units, functioning partially to entirely simultaneously, print the product bodies (16b, 17, 18) or product body parts of different product size scales at controlled speeds, and place these parts during the printing such that a previously determined spatial arrangement and bonding are obtained.

31. An apparatus for executing the method for simultaneous 3D printing of large product parts by means of synchronized printing processes, such as food, pharmaceutical products, cosmetics, and composite products made of, plastic, ceramic, or metal and natural substances, as non-symmetrical product bodies and/or non-symmetrically arranged compounds according to claim 26, characterized in that for each of the product bodies/product body parts that are to be printed, there is a printer (11a, 11b, 11c) adjusted to the respective, characteristic product size scale, composed of a print head (1a, 1b, 1c) with an appropriate print head characteristic, dosing unit (3a, 3b, 3c), temperature control unit (4a, 4b, 4c) and a robotic apparatus (2a, 2b, 2c), which form a production unit, wherein the printer (11a, 11b, 11c) can be coupled to or replaced by another corresponding printer (11a, 11b, 11c) on the robotic apparatus (2a, 2b, 2c) via a bayonet mount, wherein the components of the printer (11a, 11b, 11c) and the robotic apparatus (2a, 2b, 2c) can be controlled or regulated in a programmable manner, coordinated to one another temporally and spatially, and two or more of these production units, functioning partially to entirely simultaneously, print the product bodies (16b, 17, 18) or product body parts of different product size scales at controlled speeds, and place these parts during the printing such that a previously determined spatial arrangement and bonding are obtained.

32. An apparatus according to claim 31, characterized in that each of printers (11a, 11b, 11c) has a print head (1a, 1b, 1c) with one or more adjustable dosing units (3a, 3b, 3c), each of which is connected to one or more replaceable compound storage/supply units.

33. The apparatus according to claim 31, characterized in that the print heads (1a, 1b, 1c) generate individual droplets (13), sprays (15), or filaments (14) with one or more dosing units (3a, 3b, 3c), each of which is adapted to the rheological properties of the compounds that are to be printed.

34. The apparatus according to claim 31, characterized in that the respective dosing units (3a, 3b, 3c) are adapted to the rheological properties of the compounds that are to be printed and to the dosing kinetics of a dedicated actuator and printing nozzle geometry.

35. The apparatus according to claim 31, characterized in that the print head (1a, 1b, 1c) is adapted to the rheological properties of the compounds in the range in which they are to be printed taking irreversible structure-changing tensions in the compounds into account via the temperature control thereof with a temperature adjustment precision of ±1° C., preferably ±0.5° C., more preferably ±0.1° C.

36. A product printed by the method according to claim 26, characterized in that the product is some type of food, i.e. a chocolate product, sugar confectionery product, pasta, pastry/baked good, spread, cheese, snack composite, plant-based meat equivalent, milk product, fat product, cold cuts/pâté, dessert, or ice cream.

37. The product manufactured by the method according to claim 26, characterized in that the product (16b, 17, 18) is a cosmetic/care product, i.e. a lipstick or soap.

38. The product manufactured by the method according to claim 26, characterized in that the product (16b, 17, 18) is a pharmaceutical product, i.e. a bandage, suppository, prosthesis, corset, artificial joint, support structure, or a surgical aid for setting bones.

39. The product manufactured by the method according to claim 26, characterized in that the product is a composite product comprised of two or more materials contained in the following group: plastics, ceramics, metals and natural materials, forming a supporting element, wooden component, prosthesis, corset, or artificial joint.

40. The product manufactured by the method according to claim 26, characterized in that the product is composed of two or more compounds of the same or different composition, wherein the product bodies (16b, 17, 18) or product body parts (16b, 17, 18) produced from the compounds are of different sizes, and these product body parts are permanently secured or moveably connected to one another.

41. The product manufactured by the method according to claim 26, characterized in that the product functionality is determined with regard to feel, texture, appearance, or smell by the application-specific composition of the compounds used in the printing process with regard to the concentrations of the components that give the product its aroma, flavor, or texture, or by the respective arrangement of these compounds in the product body (16b, 17, 18) or product body parts, or by the shape of the product body (16b, 17, 18) or the product body parts, or by the details of the surface structure of the product body (16b, 17, 18) or product body parts in question.

42. The product manufactured by the method according to claim 26, characterized in that the formulas for one or more compounds are obtained from a nutritional perspective.

43. The product manufactured by the method according to claim 26, characterized in that the formulation of the compounds with regard to sugar and/or salt and/or fat content, and/or the content of other additives, and/or functionalizing components, is coordinated to the arrangement in the product body (16b, 17, 18) or product body parts in order to reduce the amounts of these components in the overall product without resulting in functional or sensory losses.

44. The product manufactured by the method according to claim 26, characterized in that an application-specific composition or the respective arrangement of the compounds in the product body (16b, 17, 18), or the dimensions of the product body (16b, 17, 18) or product body parts, or the shape of the product, or the detailed surface structure result in an intensity curve of the perception of sugar, salt, fat, or aroma that is a function of how long it takes to consume the product.

45. The product manufactured by the method according to claim 26, characterized in that the composition of the compounds forming the product body (16b, 17, 18) results in a reduction of the overall content of functionalizing components by means of a physiologically determined arrangement of the functionalized compounds, or the dimensions of the product body parts generated by these compounds, or the shape thereof, or the compound properties that affect the release of the components that determine the functions, without impairing the intended physiological effects thereof.

46. A control or regulating system for an apparatus according to claim 31 for simultaneous printing of relatively large product parts by means of synchronized printing processes in the flexible 3D printing of non-symmetrical product bodies (16b, 17, 18) or product body parts, or non-symmetrically arranged compounds in these product bodies (16b, 17, 18) from two product bodies or product body parts printed partially to fully simultaneously in different product size scales, in the centimeter range, millimeter range, or micrometer range, by printers (11a, 11b, 11c) assigned to these product size scales, in the centimeter range, millimeter range, or micrometer range, with one or more multi-axle robots, with one or more computers, which control or regulate the printers (11a, 11b, 11c) with regard to the product bodies (16b, 17, 18) or product body parts that are to be printed according to product-specific data stored in a memory in the computer in question.

47. The control or regulating system for an apparatus according to claim 46, characterized in that the printers (11a, 11b, 11c) and the coupled robotic apparatuses can be controlled or regulated according to the data stored in the memory of the computer (10a, 10b, 10c) in question with regard to their movement sequences and printing speeds, taking the rheology of the product bodies (16b, 17, 18) or product body parts into account, wherein the adjustments of the printing compound temperatures via the respective temperature control units is used as an additional correcting variable for the fine tuning of the rheological compound properties.

48. The control or regulating system according to claim 46, characterized in that the computers (10a, 10b, 10c) and the dedicated printers (11a, 11b, 11c) are incorporated in an independent daisy chain in a superordinate control or regulating algorithm.

49. The control or regulating system according to claim 46, characterized in that the central control or regulating unit (10d) controls or regulates conveyors that run continuously or intermittently to remove printed product bodies.

50. Use of a product body (16b, 17, 18) printed according to claim 26 as a chocolate product, sugar confectionery product, pasta, pastry/baked good, spread, cheese, snack composite, plant-based meat equivalent, milk product, fat product, cold cuts/pâté, dessert, or ice cream.
